(19) United States
(12) Patent Application Publication
(10) Pub. No.: US 2026/0323452 A1
(43) Pub. Date: Oct. 15, 2026

(54) NETWORK CONNECTION SWITCHING DEVICE AND NETWORK CONNECTION SWITCHING METHOD

(71) Applicant: SENAO NETWORKS, INC., Taoyuan (TW)

(72) Inventors: Yun-Hsin CHIANG, Taoyuan (TW); Yi-Chun WANG, Taoyuan (TW); Yi-Lung LIN, Taoyuan (TW)

(21) Appl. No.: 19/189,430

(22) Filed: Apr. 25, 2025

(30) Foreign Application Priority Data
Feb. 6, 2025 (TW) 114104393

(51) Int. Cl. H04W 36/14

(52) U.S. Cl. CPC H04W 36/14

(57) ABSTRACT

A switching device sets a connection timeout period and a connection checking period which is shorter than and falls within the connection timeout period. When the connection checking period expires, the switching device determines the connection status between itself and a first network device. When the connection status is determined to be invalid, the switching device switches the connection target of a user device which previously communicated with the first network device via the switching device from the first network device to a second network device with valid connection status.

### CROSS-REFERENCE TO RELATED APPLICATIONS

This application claims priority to Taiwan Patent Application No. 114104393 filed on Feb. 6, 2025, which is hereby incorporated by reference in its entirety.

### BACKGROUND OF THE INVENTION

The present invention relates to a switching device and method, and more specifically, to a network connection switching device and method.

Conventional network connection switching devices may be equipped with a connection timeout mechanism. This mechanism can terminate the connections of network devices that have not responded for a certain period (i.e., the connection timeout period) and/or clear the connection data of such network devices to prevent wasting network connection resources on unresponsive devices. However, before the connection timeout period ends (i.e., during the connection timeout period), the connections of some network devices may have already been broken. In such cases, if user devices that originally communicated with these network devices via the network connection switching device continue transmitting data to them, the transmitted data may be lost. In view of this, it is critical in the art to solve the technical problem that the transmitted data may be lost in such cases.

### SUMMARY OF THE INVENTION

To overcome the aforementioned technical problem, the present invention provides a network connection switching device. The network connection switching device may comprises a processor and a transceiver electrically connected to the processor. The processor may be configured to set a connection timeout period and a connection checking period, wherein the connection checking period is shorter than and falls within the connection timeout period. The transceiver may be configured to establish a first connection between the network connection switching device and a first network device to enable a user device to communicate with the first network device via the network connection switching device. The processor may further be configured to determine a connection status of the first connection when the connection checking period expires. Additionally, the processor may be further configured to switch a connection target of the user device from the first network device to a second network device via the transceiver when the connection status of the first connection is determined to be invalid, such that the user device communicates with the second network device through the network connection switching device.

To overcome the aforementioned technical problem, the present invention further provides a network connection switching method. The network connection switching method may be executed by a network connection switching device and may comprise: setting a connection timeout period and a connection checking period, wherein the connection checking period is shorter than and falls within the connection timeout period; determining a connection status of a first connection between the network connection switching device and a first network device when the connection checking period ends; and when the connection status of the first connection is determined to be invalid, switching a connection target of a user device from the first network device to a second network device, such that the user device communicates with the second network device via the network connection switching device.

As described above, the present invention (including the network connection switching device and the network connection switching method) additionally establishes an continuous checking mechanism within the connection timeout period. This mechanism is able to detect the disconnected network devices (e.g., the aforementioned first network device) before the connection timeout period ends (i.e., during the connection timeout period) and switch the connection target of the user device from the disconnected network devices (e.g., the first network device) to other network devices with a valid connection status (e.g., the second network device) early. In other words, through the aforementioned operation, the user device that originally communicated with the disconnected first network device via the network connection switching device can be switched beforehand to communicate with the second network device with a valid connection status via the same network connection switching device. This prevents that the user device continues transmitting data to the disconnected first network device. Accordingly, the present invention effectively improves the aforementioned technical problem.

The aforesaid content is not intended to limit the present invention, but merely provides preliminary profile of the present invention to people having ordinary skill in the art. People having ordinary skill in the art can understand the details of the present invention according to the attached drawings and the embodiments recited in the following detailed description.

### BRIEF DESCRIPTION OF DRAWINGS

FIG. 1 is a schematic diagram of a network connection switching device according to the present invention.

FIG. 2 is a schematic diagram of the overall operation of the network connection switching device shown in FIG. 1.

FIG. 3 is a schematic diagram of a network connection switching method according to the present invention.

### DETAILED DESCRIPTION OF THE INVENTION

The embodiments as disclosed below are not intended to limit the claimed invention to any specific environment, applications, structures, processes or situations. The attached drawings are proposed to assist in the description of the embodiments, but limit the protection scope of the present invention. In the attached drawings, elements which are not directly related to the claimed invention are omitted from depiction. Dimensions and dimensional relationships among individual elements in the attached drawings are only exemplary examples and are not intended to limit the claimed invention. Unless stated particularly, same element numerals may correspond to same elements in the following description without inconsistency with the claimed invention.

The terminology used herein is for the purpose of describing the embodiments only and is not intended to limit the claimed invention. The singular forms “a” and “an” are intended to include the plural forms as well, unless the context clearly indicates otherwise. The terms “comprises,” “comprising,” “includes,” “including,” etc., specify the presence of the stated features, integers, operations, elements, and/or components, but do not preclude the presence or addition of one or more other features, integers, operations, elements, components, and/or groups thereof. The term “and/or” includes any and all combinations of one or more of the associated listed items. Although the terms “first”, “second” and “third” etc., may be used herein to describe various elements, these elements should not be limited by these terms. These terms are merely used to distinguish one element from another element. Thus, for example, a “first” element could also be termed a “second” element, and vice versa, without departing from the spirit and scope of the claimed invention.

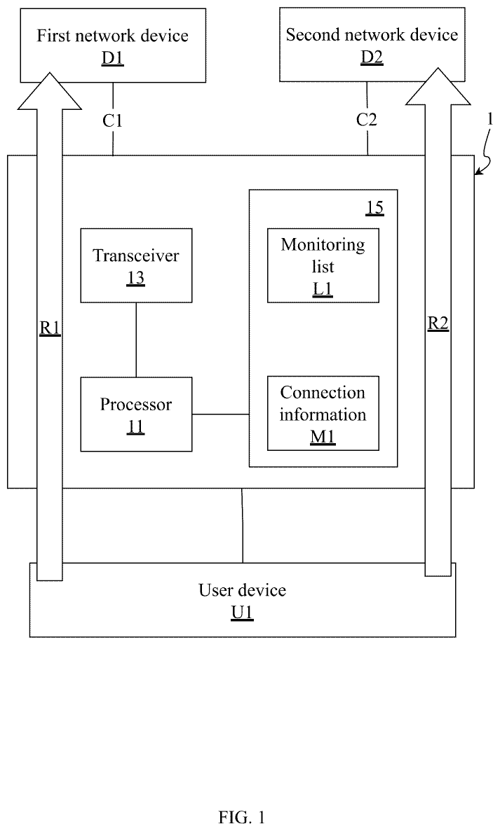

FIG. 1 is a schematic diagram of a network connection switching device according to the present invention. Referring to FIG. 1, in certain embodiments, the network connection switching device 1 may include a processor 11 and a transceiver 13 electrically connected to the processor 11. However, in certain other embodiments, in addition to the processor 11 and transceiver 13, the network connection switching device 1 may also further include a storage device 15 electrically connected to the processor 11. The electrical connection can be a direct electrical connection (i.e., connected to each other without intermediate components) or an indirect electrical connection (i.e., connected to each other through other components). The network connection switching device 1 may be any type of ancillary devices for network connection that supports Address Resolution Protocol (ARP), such as, but not limited to, a network switch. Through the network connection switching device 1, one or more user devices U1 each can communicate with various types of network devices (e.g., the first network device D1, the second network device D2, and the user device U1 as shown in FIG. 1). For example, each of the first network device D1 and the second network device D2 may be, but not limited to, a router or a server. For example, the user device U1 may be, but not limited to, a desktop computer, a laptop, a mobile phone, or any type of network connection devices.

The processor 11 may include a programmable application-specific integrated circuit (ASIC) with capabilities such as computation, storage, and input/output, and is capable of accepting and processing various encoded instructions to perform logical operations and arithmetic operations and produce corresponding operation results. The processor 11 can be programmed to interpret various instructions and perform tasks or programs, thereby completing the various processes described in this disclosure. For example, the processor 11 may be, but not limited to, a central processing unit (CPU), a digital signal processor (DSP), a microprocessor, microcontroller, or a combination thereof.

The transceiver 13 may include a transmitter and a receiver for communicating with various network devices. For wireless communication, the transceiver 13 may include, but not limited to, components such as an antenna, an amplifier, a modulator, a demodulator, a detector, an analog-to-digital converter, and a digital-to-analog converter. For wired communication, the transceiver 13 may be, for example, but not limited to, a gigabit Ethernet transceiver, a gigabit interface converter (GBIC), a small form-factor pluggable (SFP) transceiver, or a ten-gigabit small form-factor pluggable (XFP) transceiver.

The storage device 15 may be configured to store data generated by the network connection switching device 1, as well as data transmitted from external devices or the user device U1 to the network connection switching device 1. For example, the storage device 15 may include a first-level memory (also known as the main memory or the internal memory), from which the processor 11 can directly read the instruction sets and execute them as needed. The storage device 15 may also include a second-level memory (also known as the external memory or the auxiliary memory), which can transfer the stored data to the first-level memory via a data buffer. The second-level memory may include storage media such as hard drives or optical discs. Additionally, the storage device 15 may include a third-level memory, such as removable storage devices or cloud storage. Depending on requirements, the storage device 15 may include the first-level, the second-level, and/or the third-level memory.

The transceiver 13 may be configured to establish connections between the network connection switching device 1 and multiple network devices, and transmit/receive various packets with these network devices. Taking FIG. 1 as an example, the transceiver 13 may be configured to establish a first connection C1 between the network connection switching device 1 and the first network device D1, so that the user device U1 can communicate with the first network device D1 via the network connection switching device 1 (i.e., the first path R1). Similarly, the transceiver 13 may also be configured to establish a second connection C2 between the network connection switching device 1 and the second network device D2, so that the user device U1 can communicate with the second network device D2 via the network connection switching device 1 (i.e., the second path R2).

In some embodiments, the storage device 15 may be configured to store a monitoring list L1, and the processor 11 may be configured to check the connection statuses of multiple network devices via the transceiver 13 based on the monitoring list L1. Taking FIG. 1 as an example, assuming that the monitoring list L1 includes the first network device D1 and the second network device D2, the processor 11 may check the connection status of the first network device D1 (i.e., the status of the first connection C1) and the connection status of the second network device D2 (i.e., the status of the second connection C2) via the transceiver 13. The monitoring list L1 may include a self-defined list and/or an automatically generated list. The network devices listed in the self-defined list are manually established by the user of the network connection switching device 1, whereas the network devices listed in the automatically generated list are automatically created by the processor 11 via machine learning or based on packet transmission records.

In some embodiments, the storage device 15 may also be configured to store connection information M1 of the network connection switching device 1. The connection information M1 may include the status and data of connections between the network connection switching device 1 and the network devices being monitored. Taking FIG. 1 as an example, the connection information M1 may include the connection status and connection data between the network connection switching device 1 and the first network device D1, as well as the connection status and connection data between the network connection switching device 1 and the second network device D2. The processor 11 may also be configured to update the connection information M1 in real time based on the connection statuses of the network devices monitored by the network connection switching device 1. Taking FIG. 1 as an example, when the connection status of the first connection C1 is determined to be invalid, or when the connection status of the second connection C2 is determined to be invalid, the processor 11 may accordingly update the connection information M1. Optionally, the processor 11 may also be configured to notify the user device U1 of the updated connection information M1 in real time via the transceiver 13.

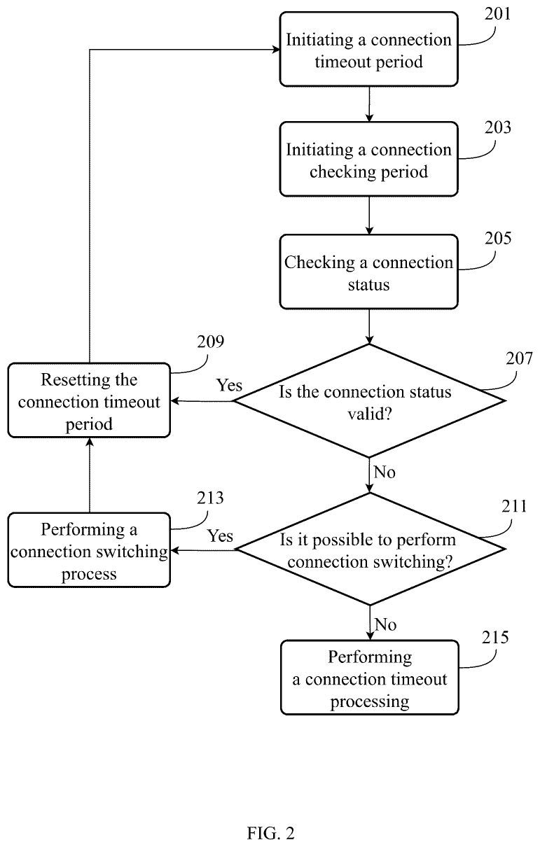

The following will describe how the network connection switching device 1 checks the connection status of multiple network devices and the corresponding subsequent processing with reference to FIG. 1 and FIG. 2 together. FIG. 2 is a schematic diagram of the overall operation of the network connection switching device 1 shown in FIG. 1. Referring to FIG. 1 and FIG. 2, the processor 11 may be configured to preset a connection timeout period and a connection checking period that is shorter than and falls within the connection timeout period. The duration of the connection timeout period and the connection checking period may be adjusted according to the requirements of different systems. For example, the processor 11 may set the connection timeout period and the connection checking period for 300 seconds and 150 seconds, respectively (or alternatively for 240 seconds and 180 seconds, 420 seconds and 60 seconds, or other configurations). Alternatively, the processor 11 may set a connection timeout period and a time difference value and then determine a connection checking period based on the connection timeout period and the time difference value. For example, the processor 11 may set the connection timeout period for 300 seconds and the time difference value to 10 seconds (or alternatively for 20 seconds, 50 seconds, 100 seconds, or other configurations), and then determine the connection checking period as 290 seconds (i.e., 300 seconds minus 10 seconds). Depending on the requirements of different systems, the processor 11 may preset the same connection timeout period and connection checking period for all monitored network devices or preset different connection timeout periods and connection checking periods for different devices.

After setting the connection timeout period and the connection checking period, the processor 11 may perform various processes on each monitored network device as shown in FIG. 2. More specifically, first, the processor 11 may simultaneously or sequentially initiate the connection timeout period and the connection checking period (labeled as process 201 and process 203). If the connection timeout period and the connection checking period are initiated sequentially, the processor 11 may determine, based on different system requirements, when to initiate the connection checking period after initiating the connection timeout period.

After initiating both of the connection timeout period and the connection checking period, when the connection checking period ends, the processor 11 may be configured to simultaneously or sequentially check the connection statuses of all of the monitored network devices (labeled as process 205). Next, the processor 11 may be configured to determine whether the connection status of any monitored network device (hereinafter referred to as the “target network device”) is valid (labeled as process 207). If the processor 11 determines that the connection status of the target network device is valid, the processor 11 may be configured to reset the connection timeout period (labeled as process 209). If the processor 11 determines that the connection status of the target network device is invalid, the processor 11 may be further configured to check, based on the monitoring list L1, whether at least one network device with a valid connection status is available for connection switching (labeled as process 211) in a way including, but not limited to, traceroute commands, ping commands, or ARP packets.

If the processor 11 determines that at least one network device in the monitoring list L1 corresponds to a valid connection status, the processor 11 may be further configured to perform a connection switching process (labeled as process 213) to switch the invalid connection path to a valid connection path. For example, in some embodiments, the connection switching process may include, but not limited to: updating the connection information M1 stored in the storage device 15, updating the monitoring list L1 stored in the storage device 15, and/or notifying the user device U1 of the updated connection information M1. For example, updating the connection information M1 may include, but is not limited to: updating the routing table, the ARP table, and/or the forwarding table.

After process 211, the processor 11 may also be configured to reset the connection timeout period (labeled as process 209). Regarding the reset of the connection timeout period, the processor 11 may be configured to update the current connection timeout period with one of the following options: maintaining the current connection timeout period, increasing the current connection timeout period by a preset time length, or decreasing the current connection timeout period by a preset time length. For example, assuming the current connection timeout period is 300 seconds, the processor 11 may be configured to set the next connection timeout period for 300 seconds (i.e., maintaining the current timeout period), 400 seconds (i.e., increasing the current timeout period of 300 seconds by a preset time length of 100 seconds), or 250 seconds (i.e., decreasing the current timeout period of 300 seconds by a preset time length of 50 seconds). After process 213, once the processor 11 successfully switches an invalid connection path to a valid connection path, the process may return to process 201 to perform the next connection processing cycle, thereby continuously checking the connection statuses of network devices.

Still referring to FIG. 2, if the processor 11 determines that there is not any network device with a valid connection status in the monitoring list L1 for connection switching, the processor 11 may be configured to perform a connection timeout processing (labeled as process 215). Specifically, the processor 11 will wait until the current connection timeout period ends, and then update the connection information M1 to remove the connection details of the network device with an invalid connection status.

The above mechanism can effectively overcome the problem of data loss. Referring to FIG. 1 for example, it is assumed that the user device U1 originally communicates with the first network device D1 which has a valid connection status via the network connection switching device 1 (i.e., on the first path R1). When the connection checking period ends, the processor 11 will check the connection status of the first network device D1 based on the monitoring list L1. If the processor 11 determines that the connection status of the first connection C1 is invalid, the processor 11 updates the connection information M1 and switches the connection target of the user device U1 from the first network device D1 to the second network device D2 with a valid connection status. As a result, the user device U1 can communicate with the second network device D2 on the second path R2 instead. In other words, by switching the first path R1 to the second path R2, the network connection switching device 1 prevents that the user device U1 continues transmitting data to the first network device D1 which has become unavailable. When the connection checking period ends, if the processor 11 determines that the first connection C1 is invalid, but the network connection switching device 1 has not yet established the second connection C2 with the second network device D2, the processor 11 can first establish the second connection C2 via the transceiver 13. After that, the processor 11 switches the connection target of the user device U1 from the first network device D1 to the second network device D2 with a valid connection status.

Once the processor 11 successfully switches the connection target of the user device U1 from the first network device D1 to the second network device D2, the processor 11 restarts the connection timeout period and the connection checking period again and continues monitoring the connection statuses of multiple network devices to ensure that the communication target of the user device U1 always has a valid connection status.

Even in cases where the network connection switching protocol is incompatible, the aforementioned mechanism can still function effectively. Referring to FIG. 1 as an example, it is assumed that the first network device D1 and the second network device D2 support a network connection switching protocol, such as the First Hop Redundancy Protocol (FHRP), but the network connection switching device 1 does not support the network connection switching protocol. More specifically, it is assumed that the first network device D1 serves as the primary router for the user device U1, while the second network device D2 acts as a backup router. Under the assumption, according to FHRP, when the first network device D1 fails or becomes unavailable, the second network device D2 will take over as the primary router for the user device U1. In addition, the processor 11 will determine the connection statuses of the two network devices when the connection checking period ends, and then accordingly updates the connection information M1 and notifies the user device U1 of the updated connection information M1. When the first network device D1 recovers, the first network device D1 will be the primary router for the user device U1 again, and the second network device D2 becomes the backup router again. At this point, the processor 11 will again determine the connection status of the two network devices when the connection checking period ends, and then accordingly updates the connection information M1 and notifies the user device U1 of the updated connection information M1. Even if the network connection switching device 1 does not support FHRP, and thus cannot automatically obtain the exchanged information between the first network device D1 and the second network device D2, the network connection switching device 1 can still detect which of the first network device D1 or the second network device D2 is the current primary router for the user device U1 in time through the above mechanism, and notify the user device U1 once any of the two network devices loses connection. Furthermore, in the case where the first network device D1 is the primary router for the user device U1, when the second network device D2 fails or recovers from failure, the network connection switching device 1 can still use the same mechanism to promptly verify the connection status of the second network device D2 and notify the user device U1 accordingly.

In some embodiments, the processor 11 may set a Hello Time defined by FHRP as the duration of the connection checking period. For example, the Hello Time of FHRP is set to 3 seconds for the first network device D1 or the second network device D2, the processor 11 may set the connection checking period for 3 seconds as well.

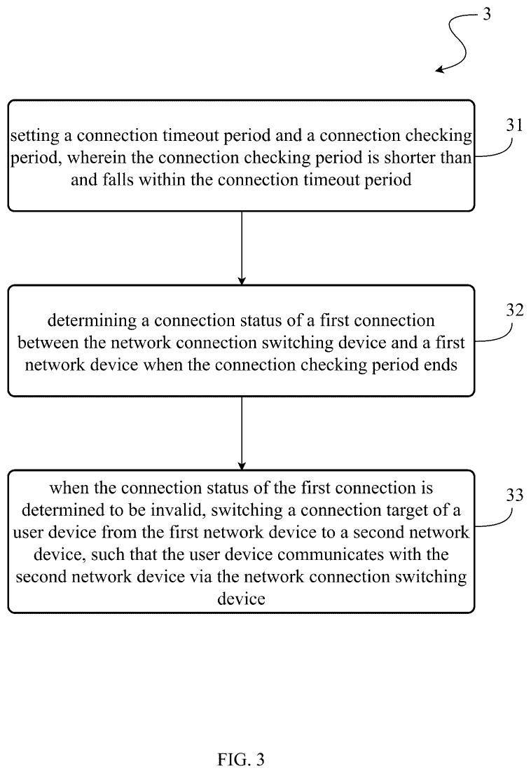

FIG. 3 illustrates a schematic diagram of a network connection switching method according to the present invention. Referring to FIG. 3, the network connection switching method 3 may be executed by a network connection switching device (such as but not limited to the aforementioned network connection switching device 1). The network connection switching method 3 may include the following steps: setting a connection timeout period and a connection checking period, wherein the connection checking period is shorter than and falls within the connection timeout period (marked as Step 31); determining a connection status of a first connection between the network connection switching device and a first network device when the connection checking period ends (marked as Step 32); when the connection status of the first connection is determined to be invalid, switching a connection target of a user device from the first network device to a second network device, such that the user device communicates with the second network device via the network connection switching device (marked as Step 33).

In some embodiments of the network connection switching method 3, the network connection switching device may store connection information of the network connection switching device, and the connection information may include a routing table, an address resolution protocol table, or a forwarding table. Optionally, to allow the user device to obtain the connection status and connection data of the network device, in some embodiments of the network connection switching method 3, the network connection switching method 3 may further include the following steps: updating the connection information when the connection status of the first connection is determined to be invalid and notifying the user device of the updated connection information.

In some embodiments of the network connection switching method 3, the network connection switching device may be a network switch.

In some embodiments of the network connection switching method 3, each of the first network device and the second network device may be a router or a server.

To continuously monitor network devices, in some embodiments of the network connection switching method 3, the network connection switching method 3 may further include the following step: resetting the connection timeout period when the connection status of the first connection is determined to be valid.

To effectively and accurately manage the network devices that need to be monitored, in certain embodiments of the network connection switching method 3, the network connection switching device may store a monitoring list. The network connection switching method 3 may further include the following step: determining the connection statuses of multiple network devices based on the monitoring list, wherein the multiple network devices include the first network device and the second network device. In these embodiments, the monitoring list may include a self-defined list and/or an automatically generated list. The self-defined list contains network devices that can be manually established by the user of the network connection switching device, whereas the automatically generated list consists of network devices that are automatically generated through machine learning by the network connection switching device.

In certain embodiments of the network connection switching method 3, the first network device and the second network device support a network connection switching protocol, but the network connection switching device does not support the network connection switching protocol. For example, the network connection switching protocol may include, but not limited to, the First Hop Redundancy Protocol. Optionally, the network connection switching device may set a Hello Time defined by the First Hop Redundancy Protocol as the duration of the connection checking period.

Each embodiment of the network connection switching method 3 substantially corresponds to at least one embodiment of the network connection switching device 1. Therefore, all of the corresponding embodiments of the network connection switching method 3 can be fully appreciated by those of ordinary skill in the art with reference to the above description of the network connection switching device 1, even though not all the embodiments of the network connection switching method 3 are described in detail above.

The above embodiments are only examples for illustrating the present invention, and are not intended to limit the scope of the claimed invention. Any other embodiments produced by modifying, changing, adjusting and integrating the above-mentioned embodiments shall all be included in the scope claimed in the present invention as long as they are not difficult for those of ordinary skill in the art to contemplate. The scope of the claimed invention shall be governed by the claims as listed.

1. A network connection switching device, comprising:
a processor, configured to set a connection timeout period and a connection checking period, wherein the connection checking period is shorter than and falls within the connection timeout period; and
a transceiver, electrically connected to the processor and configured to establish a first connection between the network connection switching device and a first network device to enable a user device to communicate with the first network device through the network connection switching device;
wherein the processor is further configured to:
determine a connection status of the first connection when the connection checking period ends; and
switches a connection target of the user device from the first network device to a second network device via the transceiver when the connection status of the first connection is determined to be invalid, such that the user device communicates with the second network device through the network connection switching device.

2. The network connection switching device of claim 1, further comprising a storage device electrically connected to the processor, wherein the storage device is configured to store connection information of the network connection switching device, and the connection information comprises a routing table, an address resolution protocol table, or a forwarding table.

3. The network connection switching device of claim 2, wherein the processor is further configured to update the connection information of the network connection switching device when the connection status of the first connection is determined to be invalid, and notify the user device of updated connection information via the transceiver.

4. The network connection switching device of claim 2, wherein the network connection switching device is a network switch.

5. The network connection switching device of claim 1, wherein each of the first network device and the second network device is a router or a server.

6. The network connection switching device of claim 1, wherein the processor is further configured to reset the connection timeout period when the connection status of the first connection is determined to be valid.

7. The network connection switching device of claim 1, further comprising a storage device electrically connected to the processor, wherein:
the storage device is configured to store a monitoring list; and
the processor is further configured to verify connection statuses of multiple network devices through the transceiver based on the monitoring list, the multiple network devices including the first network device and the second network device.

8. The network connection switching device of claim 7, wherein the monitoring list comprises a self-defined list.

9. The network connection switching device of claim 8, wherein the monitoring list further comprises an automatically generated list.

10. The network connection switching device of claim 1, wherein the first network device and the second network device support a network connection switching protocol, but the network connection switching device does not support the network connection switching protocol.

11. The network connection switching device of claim 10, wherein the network connection switching protocol is a First Hop Redundancy Protocol, and the processor sets a hello time defined by the First Hop Redundancy Protocol as duration of the connection checking period.

12. A network connection switching method, executed by a network connection switching device, comprising:
setting a connection timeout period and a connection checking period, wherein the connection checking period is shorter than and falls within the connection timeout period;
determining a connection status of a first connection between the network connection switching device and a first network device when the connection checking period ends; and
when the connection status of the first connection is determined to be invalid, switching a connection target of a user device from the first network device to a second network device, such that the user device communicates with the second network device via the network connection switching device.

13. The network connection switching method of claim 12, wherein the network connection switching device stores connection information of the network connection switching device, wherein the connection information comprises a routing table, an address resolution protocol table, or a forwarding table.

14. The network connection switching method of claim 13, further comprising: updating the connection information when the connection status of the first connection is determined to be invalid and notifying the user device of updated connection information.

15. The network connection switching method of claim 13, wherein the network connection switching device is a network switch.

16. The network connection switching method of claim 12, wherein each of the first network device and the second network device is a router or a server.

17. The network connection switching method of claim 12, further comprising: resetting the connection timeout period when the connection status of the first connection is determined to be valid.

18. The network connection switching method of claim 12, wherein the network connection switching device stores a monitoring list, and the network connection switching method further comprises:
determining connection statuses of multiple network devices based on the monitoring list, wherein the multiple network devices comprise the first network device and the second network device.

19. The network connection switching method of claim 18, wherein the monitoring list comprises a self-defined list.

20. The network connection switching method of claim 19, wherein the monitoring list further comprises an automatically generated list.

21. The network connection switching method of claim 12, wherein the first network device and the second network device support a network connection switching protocol, but the network connection switching device does not support the network connection switching protocol.

22. The network connection switching method of claim 21, wherein the network connection switching protocol is a First Hop Redundancy Protocol, and the network connection switching device sets a hello time defined by the First Hop Redundancy Protocol as duration of the connection checking period.
